(19) United States
(12) Patent Application Publication
(10) Pub. No.: US 2011/0283068 A1
(43) Pub. Date: Nov. 17, 2011

(54) MEMORY ACCESS APPARATUS AND METHOD

(75) Inventors: Chien-Ping HUNG, Hsinchu County (TW); Fong-Ray GU, Kaohsiung City (TW); Chia-Hung LIN, New Taipei City (TW); Kuo-Nan YANG, Hsinchu City (TW)

(73) Assignee: REALTEK SEMICONDUCTOR CORP., Hsinchu (TW)

(21) Appl. No.: 13/107,279

(22) Filed: May 13, 2011

(30) Foreign Application Priority Data
May 14, 2010 (TW) 099115468

(51) Int. Cl. G06F 12/00

(52) U.S. Cl. 711/154; 711/E12.001

(57) ABSTRACT

A memory access apparatus is coupled to a memory unit and includes a header access circuit and a payload access circuit. The header access circuit includes a header fetching unit used to fetch a header descriptor in the memory unit, and the payload access circuit includes a payload fetching unit used to fetch a payload descriptor in the memory unit. The header access circuit and the payload access circuit perform fetching with respect to the memory unit in a non-sequenced manner.

### CROSS-REFERENCE TO RELATED APPLICATION

This application claims priority of Taiwanese Application No. 099115468, filed on May 14, 2010, the disclosure of which is hereby incorporated by reference.

### BACKGROUND OF THE INVENTION

1. Field of the Invention

The present invention relates to direct memory access (DMA) technology.

2. Description of the Related Art

When a peripheral device desires to access a system memory, a DMA device may be used to manage movement of data so as to avoid overly occupying the operating time of a processor. For instance, in a communication system, the processor needs only to prepare a descriptor, and the network receiver uses an internal DMA device for receiving a packet including a header and a payload, and for subsequently writing the header and the payload in blocks of the system memory in sequence.

When the processor further requests that the writing of the packets must comply with the “Header Data Split” specification, the conventional DMA device can only respond by first moving the header to a block and then moving the payload to another block. However, this process increases the burden on the processor and causes a slowdown in the overall writing speed.

### SUMMARY OF THE INVENTION

Therefore, the object of the present invention is to provide a memory access apparatus and method that enable writing of a packet in a manner complying with the “Header Data Split” specification so as to reduce the burden of a processor and increase speed.

According to a first aspect, the memory access apparatus of this invention is coupled to a memory unit and comprises a header access circuit and a payload access circuit. The header access circuit includes a header fetching unit used to fetch a header descriptor in the memory unit, and the payload access circuit includes a payload fetching unit used to fetch a payload descriptor in the memory unit. The header access circuit and the payload access circuit perform fetching with respect to the memory unit in a non-sequenced manner.

According to a second aspect, the memory access apparatus of this invention is coupled to a memory unit and comprises a header access circuit and a payload access circuit. The header access circuit includes a header fetching unit used to fetch a header descriptor in the memory unit, and a header moving unit used to write a header of a packet to a first block of the memory unit according to the header descriptor. The payload access circuit includes a payload fetching unit used to fetch a payload descriptor in the memory unit, and a payload moving unit used to write a payload of the packet to a second block of the memory unit according to the payload descriptor. The header access circuit writes the header to the first block and the payload access circuit writes the payload descriptor to the second block in a non-sequenced manner.

According to a third aspect, the memory access method of this invention comprises the steps of: fetching a header descriptor from a memory unit; fetching a payload descriptor from the memory unit; receiving a packet including a header and a payload; writing the header to a first block of the memory unit according to the header descriptor; and writing the payload to a second block of the memory unit according to the payload descriptor. The step of writing the header to the first block of the memory unit and the step of writing the payload to the second block of the memory unit are performed in a non-sequenced manner.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram, illustrating a first preferred embodiment of a memory access apparatus according to the present invention;

FIG. 2 is a flowchart of a first preferred embodiment of a memory access method according to the present invention; and

FIG. 3 is a schematic diagram, illustrating the arrangement of headers and payloads in a memory unit.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

### First Preferred Embodiment

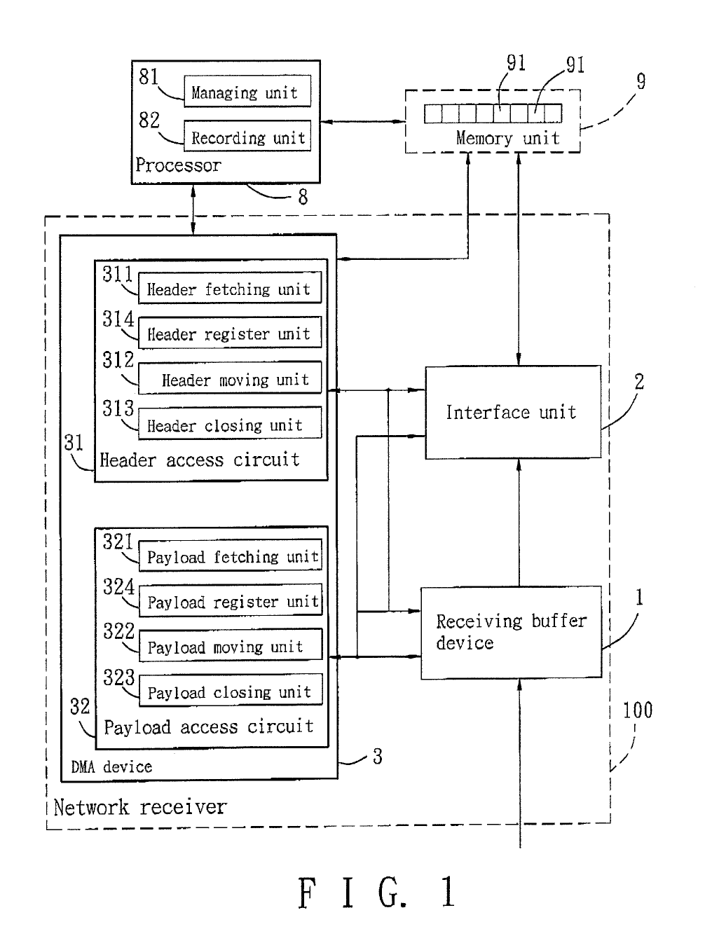

Referring to FIG. 1, a first preferred embodiment of a memory access apparatus 3 according to the present invention is used in a network receiver 100, and the network receiver 100 is coupled electrically to a processor 8 and a memory unit 9. Preferably, the memory access apparatus 3 is a DMA device.

Every time the network receiver 100 receives a packet that includes a header and a payload, the DMA device 3 installed therein refers to a header descriptor recorded in the memory unit 9 to write the header to the memory unit 9, and also refers to a payload descriptor recorded in the memory unit 9 write the payload to the memory unit 9. These two descriptors are planned and recorded by the processor 8 in advance.

The network receiver 100 comprises a receiving buffer device 1, an interface unit 2, and the DMA device 3, which are electrically interconnected. The DMA device 3 includes a header access circuit 31 and a payload access circuit 32. The header access circuit 31 includes a header fetching unit 311, a header moving unit 312, and a header closing unit 313. The payload access circuit 32 includes a payload fetching unit 321, a payload moving unit 322, and a payload closing unit 323.

In addition, the processor 8, which is coupled electrically to the network receiver 100, includes a managing unit 81 and a recording unit 82, and the memory unit 9 includes a plurality of blocks 91.

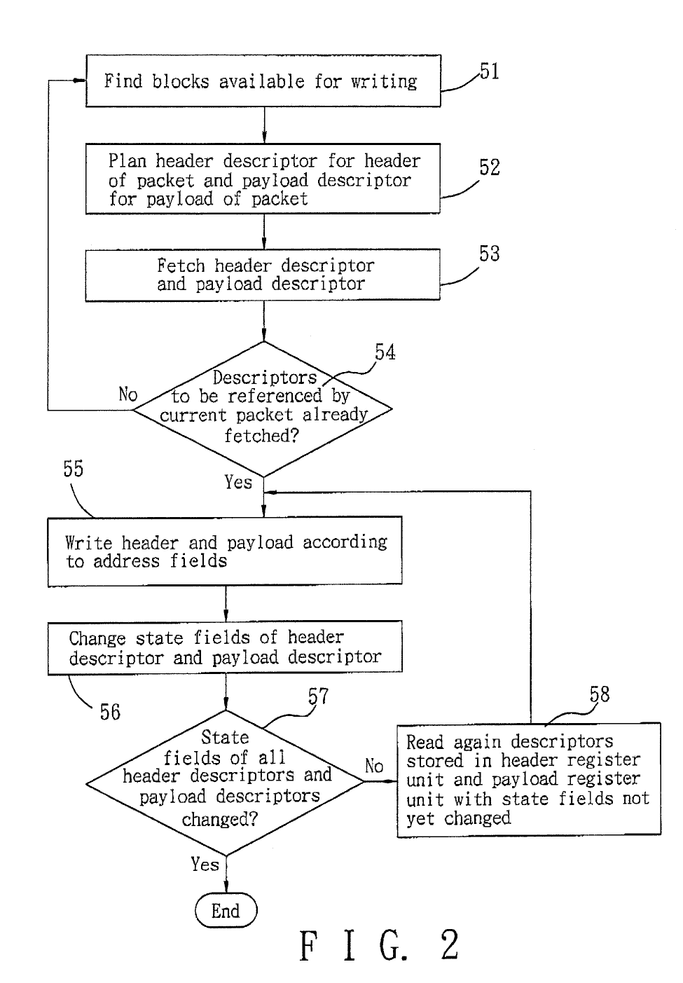

Referring to FIG. 2, a memory access method according to a first preferred embodiment of the present invention, which is implemented through the memory unit 9, the processor 8, and the network receiver 100, comprises the steps as outlined below.

In step 51, the processor 8 uses the managing unit 81 to monitor the blocks 91 of the memory unit 9 so as to find the blocks 91 available for writing by the network receiver 100.

In step 52, based on the blocks 91 found to be available, the managing unit 81 starts to plan a header descriptor for the header of a packet, and a payload descriptor for the payload of the packet. Furthermore, each planned descriptor is recorded into a block 91 of the memory unit 9 by the recording unit 82.

Each header descriptor includes an address field for indicating a first block for writing by the network receiver 100, and a first state field. When the first state field has a value of 1, this indicates that the network receiver 100 owns the first block, such that the first block is “write-enabled” for the network receiver 100. When the first state field has a value of 0, this indicates that the processor 8 owns the first block, such that the first block is “write-disabled” for the network receiver 100.

Similarly, each payload descriptor includes an address field for indicating a second block for writing by the network receiver 100, and a second state field. When the second state field has a value of 1, this indicates that the second block is “write-enabled” for the network receiver 100. When the second state field has a value of 0, this indicates that the second block is “write-disabled” for the network receiver 100.

At the initial stage of planning, each state field is in a “write-enabled” state, i.e., has a default value of 1.

In step 53, the DMA device 3 uses the header fetching unit 311 of the header access circuit 31 to fetch a related header descriptor from the memory unit 9 for a packet to be received. Furthermore, the DMA device 3 uses the payload fetching unit 321 of the payload access circuit 32 to fetch a related payload descriptor from the memory unit 9 for the packet to be received.

In step 54, when the receiving buffer device 1 receives a packet, the header fetching unit 311 of the header access circuit 31 and the payload fetching unit 321 of the payload access circuit 32 check whether the descriptors to be referenced by the current packet have been fetched. If not, steps 51 to 53 are repeated until these descriptors are fetched. If so, the flow proceeds to step 55.

It is to be noted that the header access circuit 31 further includes a header register unit 314 for temporary writing of the descriptors fetched by the header fetching unit 311. Moreover, the payload access circuit 32 further includes a payload register unit 324 for temporary writing of the descriptors fetched by the payload fetching unit 321.

In step 55, with respect to the current packet, the header access circuit 31 uses the header moving unit 312 to write the header in the corresponding block 91, i.e., the first block, through the interface unit 2 and according to the address field of the header descriptor in the header register unit 314.

Moreover, the payload access circuit 32 uses the payload moving unit 322 to write the payload in the corresponding block 91, i.e., the second block, through the interface unit 2 and according to the address field of the payload descriptor in the payload register unit 324.

Subsequently, in step 56, with respect to the current packet, the header closing unit 313 changes the state field of the header descriptor in the memory unit 9 to indicate that the first block is changed from “write-enabled” to “write-disabled.” Also, the payload closing unit 323 changes the state field of the payload descriptor in the memory unit 9 to indicate that the second block is changed from “write-enabled” to “write-disabled.”

Next, each of the header closing unit 313 and the payload closing unit 323 sends an interrupt signal to the managing unit 81, such that the managing unit 81 checks whether data has been written into the block 91 corresponding to the address field.

In step 57, the DMA device 3 checks whether the state fields of all the header descriptors and the payload descriptors are changed. If not, the descriptors stored in the header register unit 314 and the payload register unit 324 and with state fields not yet changed are again read, after which the flow goes back to step 55. If so, the process of accessing the current packet is terminated.

Moreover, the next packet may also by written into the memory unit 9 a imply by repeating the above procedure.

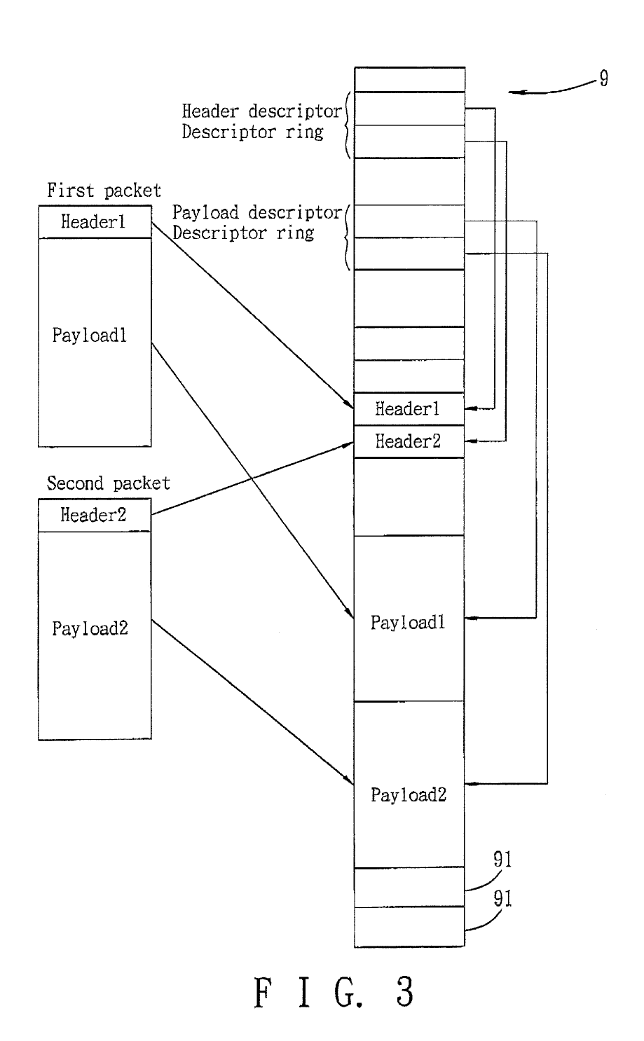

Referring to FIG. 3, it is to be noted that when the available memory space in the memory unit 9 is sufficiently large, the managing unit 81 of this embodiment will plan the descriptors such that the headers of consecutive packets can be collected and written into a plurality of consecutive first blocks, and the payloads of consecutive packets can be collected and written into a plurality of consecutive second blocks. In such a manner, when the DMA device 3 completes movement of the packets, not only can the requirement to comply with the “Header Data Split” specification be met, but when the processor 8 subsequently desires to use these headers or payloads, the content of all the blocks 91 can be moved to a cache memory for use, thereby increasing processing speed and reducing the possibility of rewriting the cache memory or not being able to find data in the cache memory. Moreover, for the same packet, since the header access circuit 31 and the payload access circuit 32 do not need to be operated in sequence, the data of different areas of the packets can be written in the memory unit 9 substantially at the same time so as to increase the speed of packet access. Non-sequential operation refers to header fetching operations (or data moving operations or descriptor closing operations) of the header access circuit 31 and the payload access circuit 32 not being conducted in sequence. In practice, the operations of both of these elements may be conducted synchronously or part of the operating time periods thereof may overlap.

In addition, the managing unit 81 will also plan such that the header descriptors of consecutive packets can be collected and written into another set of consecutive blocks 91, and the payload descriptors of consecutive packets can be collected and written into yet another set of consecutive blocks 91. Furthermore, in order to save memory space, in practice, the managing unit 81 will repeatedly reuse the blocks 91 that store the descriptors, collect header descriptors of an N-number of consecutive packets to form a header descriptor ring, and collect payload descriptors of an N-number of consecutive packets to form a payload descriptor ring.

For example, if the DMA device 3 refers to an nth descriptor of the payload descriptor ring (where 1<=n<=N) for writing the payload of an nth packet, then when the (N+1)th packet is received, the first descriptor is referenced again, and when the (N+2)th packet is received, the second descriptor is referenced again, and so on.

It is to be noted that since the state field of the descriptor is “write-disabled” after the packet content is written, the managing unit 81 will receive the interrupt signal. With repeated use, the managing unit will actively change the state field to “write-enabled,” and further change the address field to indicate another block 91 suitable for writing.

Moreover, if the processor 8 no longer uses the content written in the block 91 indicated by the descriptor, the managing unit 81 will also in this case change the state field to be “write-enabled,” but will maintain original address field. In this manner, the DMA device 3 follows each ring to re-write the contents of the packets into the original blocks 91.

### Second Preferred Embodiment

The second preferred embodiment of this invention differs from the first preferred embodiment in that the packet that the network receiver 100 receives includes (H) headers and a payload, where H>=1.

As known by those skilled in the art of this invention, a signal transmitting end sends a pending packet only after being processed by the seven protocol layers specified by the OSI (open systems interconnection) model. Through the process of each layer, a header specific for that layer will be added on. Therefore, each packet may have up to seven headers.

Referring back to FIG. 1, in this embodiment, the managing unit 81 will plan a header descriptor separately for each of the (H) headers of the packet. Next, the DMA device 3 uses (H) header access circuits 31 and one payload access circuit 32 to conduct packet access. To simplify illustration, in FIG. 1, H=1.

In further detail, when the DMA device 3 processes each packet, the (H) header access circuits 31 may first fetch the header descriptors of the related headers from the memory unit 9 through the respective header fetching units 311 and record the header descriptors in the header register units 314, then through the header moving units 312, write the corresponding headers to the first block indicated by the related headers, and finally change the first state fields of the related header descriptors in the memory unit 9 respectively through the header closing units 313. On the other hand, the DMA device 3 also uses the payload access circuit 32 to write the payload using the method of the first preferred embodiment to complete receipt of the entire packet.

### Third Preferred Embodiment

When the payload included in a packet has a significant length, the DMA device 3 also can perform processing in segments. For instance, in a state where the payload is divided into (P) segments (where P>=1), the managing unit 81 will plan a payload descriptor separately for each of the (P) payload segments to be placed in the memory unit 9.

Therefore, apart from using a header access circuit 31 to write the header using the method of the first preferred embodiment, the DMA device 3 also uses the (P) payload access circuits 32 for accessing the (P) payload segments. To simplify illustration, in FIG. 1, P=1.

The (P) payload access circuits 32 will fetch the payload descriptors of the corresponding payload segments from the memory unit 9 through the respective payload fetching units 321, and record the payload descriptors in the payload register units 324, then write the corresponding payload segments to the second block indicated by the related payload descriptor respectively through the payload moving units 322, and then change the second state fields of the related payload descriptors in the memory unit 9 respectively through the payload closing units 323. In such a manner, access of the entire packet is completed, and the time for moving the packet is reduced.

It is to be noted that, preferably, the (P) payload descriptors planned by the managing unit 81 indicate (P) second blocks with consecutive addresses. Therefore, when the processor 8 subsequently uses the payload of the packet, the (P) payload descriptors may be read from the (P) consecutive second blocks and moved to a cache memory (not shown) for use.

### Fourth Preferred Embodiment

A packet received by the network receiver 100 may also include (H) headers (where H>=1) and (P) payload segments (where P>=1), and the DMA device 3 includes (H) header access circuits 31 and (P) payload access circuits 32. To simplify illustration, in FIG. 1, H=1 and P=1.

Each header access circuit 31 writes the corresponding header using the method of the second preferred embodiment, and each payload access circuit 32 writes the corresponding payload using the method of the third preferred embodiment. In such a manner, receipt of the entire packet is completed.

Preferably, the data moving capability of the header moving unit 312 of the DMA device 3 and the data moving capability of the payload moving unit 322 of the DMA device 3, that is, the bandwidths and the hardware of both, may be configured according to a predetermined ratio. For instance, within a predetermined time period, if the average header moving quantity is 2M and the average payload moving quantity is 25.3M, such that the ratio between the data moving capability of the header moving unit 312 and the data moving capability of the payload moving unit 322 is 2:25, the data moving operations of both can be completed substantially at the same time, and hence the time of moving the entire packet is shortened.

In conclusion, the foregoing DMA device 3 uses different descriptors for reference in writing headers and payloads. Therefore, the requirement to comply with the “Header Data Split” specification can be met, the burden of the processor 8 can be reduced, and the processing speed can be increased. Hence, the objects of this invention are realized.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A memory access apparatus coupled to a memory unit, said memory access apparatus comprising:
a header access circuit including a header fetching unit used to fetch a header descriptor in the memory unit; and
a payload access circuit including a payload fetching unit used to fetch a payload descriptor in the memory unit;
wherein said header access circuit and said payload access circuit perform fetching with respect to the memory unit in a non-sequenced manner.

2. The memory access apparatus as claimed in claim 1, wherein said header access circuit further includes a header moving unit, and said payload access circuit further includes a payload moving unit;
wherein, when said memory access apparatus receives a packet including a header and a payload, said header moving unit writes the header to a first block of the memory unit according to the header descriptor, and said payload moving unit writes the payload to a second block of the memory unit according to the payload descriptor.

3. The memory access apparatus as claimed in claim 2, wherein said header moving unit writing the header to the first black and said payload moving unit writing the payload to the second block are performed in a non-sequenced manner.

4. The memory access apparatus as claimed in claim 2, wherein the data moving capability of said header moving unit and the data moving capability of said payload moving unit are configured according to a predetermined ratio.

5. The memory access apparatus as claimed in claim 4, wherein the predetermined ratio is determined by a ratio value between an average header moving quantity and an average payload moving quantity within a predetermined time period.

6. The memory access apparatus as claimed in claim 1, wherein said header access circuit further includes a header moving unit, and said payload access circuit further includes a payload moving unit;
wherein, when said memory access apparatus receives a plurality of packets each including a header and a payload, said header moving unit writes the headers to a plurality of consecutive first blocks of the memory unit according to the header descriptor, and said payload moving unit writes the payloads to a plurality of consecutive second blocks of the memory unit according to the payload descriptor.

7. The memory access apparatus as claimed in claim 3, wherein:
the header descriptor further includes a first state field that is used to indicate whether the first block is write-enabled or write-disabled, and the payload descriptor further includes a second state field that is used to indicate whether the second block is write-enabled or write-disabled; and
said header access circuit further includes a header closing unit for changing the first state field, and said payload access circuit further includes a payload closing unit for changing the second state field.

8. A memory access apparatus coupled to a memory unit, said memory access apparatus comprising:
a header access circuit including a header fetching unit used to fetch a header descriptor in the memory unit, and a header moving unit used to write a header of a packet to a first block of the memory unit according to the header descriptor; and
a payload access circuit including a payload fetching unit used to fetch a payload descriptor in the memory unit, and a payload moving unit used to write a payload of the packet to a second block of the memory unit according to the payload descriptor;
wherein said header access circuit writes the header to the first block and said payload access circuit writes the payload descriptor to the second block in a non-sequenced manner.

9. The memory access apparatus as claimed in claim 8, wherein the data moving capability of said header moving unit and the data moving capability of said payload moving unit are configured according to a predetermined ratio.

10. The memory access apparatus as claimed in claim 9, wherein the predetermined ratio is determined by a ratio value between an average header moving quantity and an average payload moving quantity within a predetermined time period.

11. The memory access apparatus as claimed in claim 8, wherein the header descriptor further includes a first state field that is used to indicate whether the first block is write-enabled or write-disabled, and the payload descriptor further includes a second state field that is used to indicate whether the second block is write-enabled or write-disabled; and
said header access circuit further includes a header closing unit for changing the first state field, and said payload access circuit further includes a payload closing unit for changing the second state field.

12. A memory access method comprising the steps of:
fetching a header descriptor from a memory unit;
fetching a payload descriptor from the memory unit;
receiving a packet including a header and a payload;
writing the header to a first block of the memory unit according to the header descriptor; and
writing the payload to a second block of the memory unit according to the payload descriptor;
wherein said step of writing the header to the first block of the memory unit and said step of writing the payload to the second block of the memory unit are performed in a non-sequenced manner.

13. The memory access method as claimed in claim 12, further comprising the step of:
changing a first state field of the header descriptor and a second state field of the payload descriptor;
wherein the first state field indicates whether the first block is write-enabled or write-disabled, and the second state field indicates whether the second block is write-enabled or write-disabled.

14. The memory access method as claimed in claim 12, wherein said step of fetching the header descriptor from the memory unit and said step of fetching the payload descriptor from the memory unit are performed in a non-sequenced manner.
